(19) United States
(12) Patent Application Publication
(10) Pub. No.: US 2016/0104217 A1
(43) Pub. Date: Apr. 14, 2016

(54) METHOD AND SYSTEM FOR EVALUATING AND PROMOTING REAL ESTATE AGENTS

(71) Applicant: GeoJet Information Solutions Inc., Calgary (CA)

(72) Inventor: Ziqin DU, Calgary (CA)

(21) Appl. No.: 14/513,499

(22) Filed: Oct. 14, 2014

(51) Int. Cl. G06Q 30/02

(52) U.S. Cl. CPC G06Q 30/0282

(57) ABSTRACT

A system and computer implemented method of rating a real estate agent is disclosed herein. The method includes: retrieving agent sales data stored at a memory device; determining at least one common sales metric value for each of the agents; sorting the agents to produce a sequence listing of the agents in an order based on the determined sales metric; assigning a rating to each agent in accordance with a sequence number of the agent in the sorted list; rendering a report based on the rating.

### FIELD

The embodiments disclosed herein relate to methods and systems for rating real estate agents based on objective metrics.

### BACKGROUND

Real estate properties are sold and bought through local or regional Multiple Listing Systems (MLS) where listings are shared by local real estate offices or brokers. Such systems attract a large audience of buyers and sellers. Sales personnel who represent the seller or buyer in such a real estate transaction platform are referred to as real estate agents. In the U.S. there are over 1 million realtors who are qualified and registered real estate agents. Real estate agents are generally compensated by the commission they earned from the sales they closed or completed.

The above information is presented as background information only to assist with an understanding of the present disclosure. No determination has been made, and no assertion is made, as to whether any of the above might be applicable as prior art with regard to the present disclosure.

### SUMMARY

In a first aspect this disclosure provides a computer implemented method of rating a real estate agent, the method executed by a physical processor of said computer, the method comprising: retrieving agent sales data stored at a memory device; determining at least one common sales metric value for each of the agents; sorting the agents to produce a sequence listing of the agents in an order based on the determined sales metric; assigning a rating to each agent in accordance with a sequence number of the agent in the sorted list; rendering a report based on the rating.

In an embodiment, agents having the same value of a metric are assigned the same rating when the rating is based on that metric.

In various embodiments, the sales metric can include: a number of sales in a time period, a dollar volume, the dollar volume comprising a sum of the sale price of the sales closed by an agent in a time period, a number of returning customers, a percentage of returning customers or a combination thereof.

In an embodiment, the method further includes: receiving user input for restricting the rating based on at least one criterion; and restricting the data used in the determining step based on the user input.

In an embodiment, the at least one criterion can include a service type of an agent. The service type can include categories such as seller's agent, buyer's agent, or “both”. The both category can also be referred to as the “seller's and buyer's agent” category. The seller's agent category corresponds to agents that represent sellers, the buyer's agent category corresponds to agents that represent both buyers, and the “both” category corresponding to agents that represent both buyers and sellers.

In an embodiment, the at least one criterion can include a property type. Examples of property types can include, but are not limited to, single family residential, townhouses, lands, apartments, high rise condominiums, low rise condominiums, lofts, cottage properties, and multi-family properties.

In an embodiment, the at least one criterion can include a service area. Examples of service areas can include or be defined by: community/neighborhood boundaries, school or school district service boundaries, city/county or zip code area boundaries, a distance from a university or lake front or other landmark, a foot print of one high-rise apartment building, an area drawn or defined by a user. The user can include, for example, a real estate agent or a customer.

In an embodiment, agents having the same value of a metric are assigned the same rating when the rating is based on that metric.

In an embodiment, the at least one criterion can include a time window. Examples of time windows can include, but are not limited to, monthly, quarterly, annually, and user specified time window. The user can include, for example, a real estate agent or a customer.

In an embodiment, the at least one criterion can include any combination of any of the above described criteria.

In another aspect, the present disclosure provides a computer readable medium storing statements and instructions for execution by a processor for executing any of the aforementioned methods.

In another aspect, the present disclosure provides a system for rating a real estate agent, the system comprising at least one physical processor, the processor configured and adapted to: retrieve agent sales data stored at a memory device; determine at least one common sales metric for each of the agents; sort the agents to produce a sequence listing of the agents in an order based on the determined sales metric; assign a rating to each agent in accordance with a sequence number of the agent in the sorted list; render a report based on the rating.

In an embodiment, agents with the same value the metric are assigned the same rating.

In various embodiments, the sales metric can include: a number of sales in a time period, a dollar volume, the dollar volume comprising a sum of the sale price of the sales closed by an agent in a time period, a number of returning customers, a percentage of returning customers or a combination thereof.

In an embodiment, the processor is further configured and adapted to: receive user input for restricting the rating based on at least one criterion; and restrict the data used in the determining step based on the user input.

In an embodiment, the at least one criterion can include a service type of an agent. The service type can include categories such as seller's agent, buyer's agent, or “both”. The both category can also be referred to as the “seller's and buyer's agent” category. The seller's agent category corresponds to agents that represent sellers, the buyer's agent category corresponds to agents that represent both buyers, and the “both” category corresponding to agents that represent both buyers and sellers.

In an embodiment, the at least one criterion can include a property type. Examples of property types can include, but are not limited to, single family residential, townhouses, lands, apartments, and multi-family properties.

In an embodiment, the at least one criterion can include a service area. Examples of service areas can include or be defined by: community/neighborhood boundaries, school or school district service boundaries, city/county or zip code area boundaries, a distance from a university or lake front or other landmark, a foot print of one high-rise apartment building, an area drawn or defined by a user. The user can include, for example, a real estate agent or a customer.

In an embodiment, the at least one criterion can include a sales price.

In an embodiment, the at least one criterion can include a time window. Examples of time windows can include, but are not limited to, monthly, quarterly, annually, and user specified time window. The user can include, for example, a real estate agent or a customer.

In an embodiment, the at least one criterion can include any combination of any of the above described criteria.

In an embodiment, the processor is further configured and adapted to export a rating chart. Exporting a rating chart can include exporting an image file comprising a rating chart; exporting a dynamic rating chart; emailing an image file comprising a rating chart; emailing a dynamic rating chart; or a combination thereof. The dynamic rating chart can be embedded in a web page or other electronic document. As an example, the dynamic rating chart can be an interactive chart where a user can interact with the chart. In an embodiment, the user can interact with the chart by adjusting one or more of the above-described criteria. In some embodiments, the dynamic chart can be exported by an agent and the agent can restrict the extent to which a user (e.g. a prospective buyer or seller who may hire the agent) can interact with the chart. For example, the agent may restrict which of the criteria that may be adjusted and/or the range within which they may be adjusted.

In an embodiment, the processor is further configured and adapted to automatically determine a set of criteria that produces a best rating for a selected agent. The set of criteria can, for example, include one or more of the following: service type, service area, property classes (or property type), price range, and time period. In an embodiment, the automatic determination is performed by first performing a series of rating using different criteria parameters; and then selecting the parameters that result in the best rating for the selected agent.

In an embodiment, the rendered report comprises a chart for displaying an agent's current and historic listing. In an embodiment, the chart can further display a dollar volume of sales for the agent. In an embodiment, the system allows a user to select at least one of the following parameters for display as part of the chart: number of sales, number of new listings, dollar volume of sales, buyers/seller percentage, property class (or property type) distributions. In an embodiment, the user can select a time window for the chart.

In an embodiment, the system allows a user to select the time interval for which each agent's individual statistics are rendered. The time intervals can be, for example, but are not limited to: monthly, quarterly, annually, year to date.

In an embodiment, the processor is further configured and adapted to: export the chart to an image file or to export the chart as a dynamic chart to a webpage or an electronic document.

In an embodiment, the chart includes at least one pie chart. The at least one pie chart can relate to, for example: a percentage of services for buyers and sellers, a percentage of services for different property classes, and a percentage of services in an agent's service areas. In an embodiment, there are three pie charts, where each pie chart relates to one of three preceding examples.

In an embodiment, the system is coupled to a real estate listing web portal; and the processor is further configured and adapted to match a customer's request for service to an agent based on a rating of the agent and a customer's requested service area.

In another aspect, the present disclosure provides a computerized real estate agent promoting or referral system as used in a real estate listing web portal that matches a consumer's request of service to agents. The matching is performed based on a rating method, for example such as those methods described above, which ranks the agent's past performance. In some embodiments, the past performance is rated in the context of the similar services as those requested by the consumer. The term similar services can mean services with similar criteria as the service requested by the customer (e.g. prospective buyer or seller) and the criteria can include any of the criteria as described above or any other suitable criteria. In some embodiments, the performance is determined by the number of sales or sales' dollar volume executed by the agent.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a block diagram illustrating components of a system in accordance with an embodiment of the present invention;

FIG. 2 illustrates a user Interface in accordance with an embodiment of the present invention;

FIG. 3 illustrates another user Interface in accordance with an embodiment of the present invention;

FIG. 4 illustrates a report generated in accordance with an embodiment of the present invention;

FIG. 5 illustrates a report that may be generated as part of a report in accordance with an embodiment of the present invention; and

FIG. 6 is a flow chart diagram illustrating a method in accordance with an embodiment of the present invention.

### DETAILED DESCRIPTION

Traditionally, consumers reach and select real estate agents through family/friends' referrals, and advertising media such as local newspapers, magazines, local/community display billboards. With the advance of the Internet, consumers can request the service of a real estate agent through the local real estate association's website or a third party real estate listing web portal. Such websites provide listings of the agents to consumers either alphabetically by the agents' name from its agent database or its collection of agents who paid to have their names supplied to consumers. The disclosure of agents in such systems lacks information that is reflective of the quality of these agents.

Potential home sellers and buyers, as is the case with most consumers of virtually any service, generally would like to hire qualified service providers or even sometimes the top service provider. To cater to such desires, many internet portals such as tulia.com, zillow.com, and realtor.com, allow consumers to enter ratings of agents in their web sites. Agents are typically rated by a 5-star system. Such ratings do provide some information about some agents to consumers that may aid the consumers' selection of agents. However, such rating systems generally have many drawbacks, and can even be very controversial.

One drawback is that the afore-mentioned type of rating is subjective. That is, the same quality or level of service can be rated as a 5-star quality of service by one consumer and as a 3-star level of service by another consumer.

Another drawback is that the rating is produced based on a limited set of users. For example, it is generally the case that not all the consumers and not all the agents participate in such systems.

A further drawback is that such rating systems can be prone to fraud. For example, an unscrupulous agent could pay an amount, say $20, to a reviewer in exchange for a positive review, or pay $2K a month to turn one-star reviews into 5-star reviews. Alternatively, an agent could be unfairly victimized by being pulled out of the system and placed on a ‘not recommended’ page by some unknown consumers/reviewers. Generally, in such systems the credentials of those consumers who provide the ratings are not checked or verified.

Due to such issues, the National Association of Realtors, the trade organization of realtors across the United States of America, initiated its own agent rating system in 2012. In the proposal, a standard user satisfaction survey/questionnaire is distributed to sellers/buyers of a realtor who participated in the program. The survey results are submitted to and compiled by an independent contractor. The results are published on a website as a reference for new consumers who are in the process hiring a real estate agent. This method aims to address, to some degree, two problems in the rating system in a public listing portal: the credentials of the consumers participating in the rating is managed, and a standard set of questions and score system are provided in an attempt to make the ratings more reliable and more trustworthy. After two years of trials, however, the program was discontinued due to the low participation rate of real estate agents. While agents may benefit from good ratings, they made themselves vulnerable to bad ratings which they may not agree with and have no control over. Agents just want everything to be fair, not make it easy for unreasonable/irrational/inflammatory comments to impact their reputation. In other words, the subjective nature of the rating is still embedded in this system.

An embodiment of this invention provides a method and system to evaluate and promote a real estate agent. Specifically, an embodiment of the invention uses the sales of real properties by a real estate agent, and compares them with comparable sales closed by other agents. A rank or finding is achieved by restricting the closed sales within a certain time period, a certain geographical area, certain property classes including price range, and the business of selling or buying. An embodiment of the invention provides a system to utilize the findings in an agent's social media and webpage, and in a real estate listing web portal to recommend an agent to consumers who are interested in the real estate buying/selling the agent performed the best.

An embodiment of the present invention includes a rating system based on the past achievement of a real estate agent. In various embodiments, the method and the resulting rating is objective, scientific, and creative. The system further includes functions to promote an agent's business by utilizing the rating.

Various embodiments disclosed herein provide methods and systems that can be used to generate a rating of a real estate agent's performance based on certain objective metrics (e.g. measure performance based on objective data). The metrics can include or measure performance data such as the number of sales executed and the total dollar volume of sales of the agent. The rating methods and systems disclosed herein can compare the relative performance of an agent to his or her peers. Accordingly, embodiments disclosed herein can be used to generate an objective rating that is based on actual performance data. In some embodiments, the user can select the metrics that are used. The user can be, for example but not limited to, a prospective customer of an agent or the agent him/herself. In the case where the agent is rating him/herself, the agent can select criteria for the rating that highlights his or her strengths and produces a rating that maximizes their ranking in the rating. For example, a particular agent's business may be differentiated or characterized by, for example but not limited to, a property class (e.g. high rise condominiums), a particular price range (which may correspond to luxury homes), a particular client type (e.g. buyer's agent), a particular service area (e.g. Downtown Toronto). The agent can incorporate those factors to highlight his or her strengths in the rating. For example, the user can restrict the rating based on one or more of the above mentioned criteria so that they are, for example, only rated based on performance in a particular service area or alternatively in a particular service area and a particular property class (e.g. high rise condominiums in downtown Toronto). The systems and methods further allow the user to restrict the rating to a particular time period to further highlight their strengths. In some embodiments, the system is able to automatically determine the criteria that maximize the agent's ranking in the rating. In an embodiment, this is achieved by the system performing a number of rankings while varying various variables, which may include any of the above-discussed criteria including a time window during which the rating is conducted, and selecting the criteria that result in the highest ranking of the agent. Accordingly, some embodiments of the disclosed systems and methods can be used as a powerful tool to promote an agent by generating a rating of the agent that is not only based on objective metrics (e.g. objectively measured data) but also highlights the performance of the agent in the best possible light.

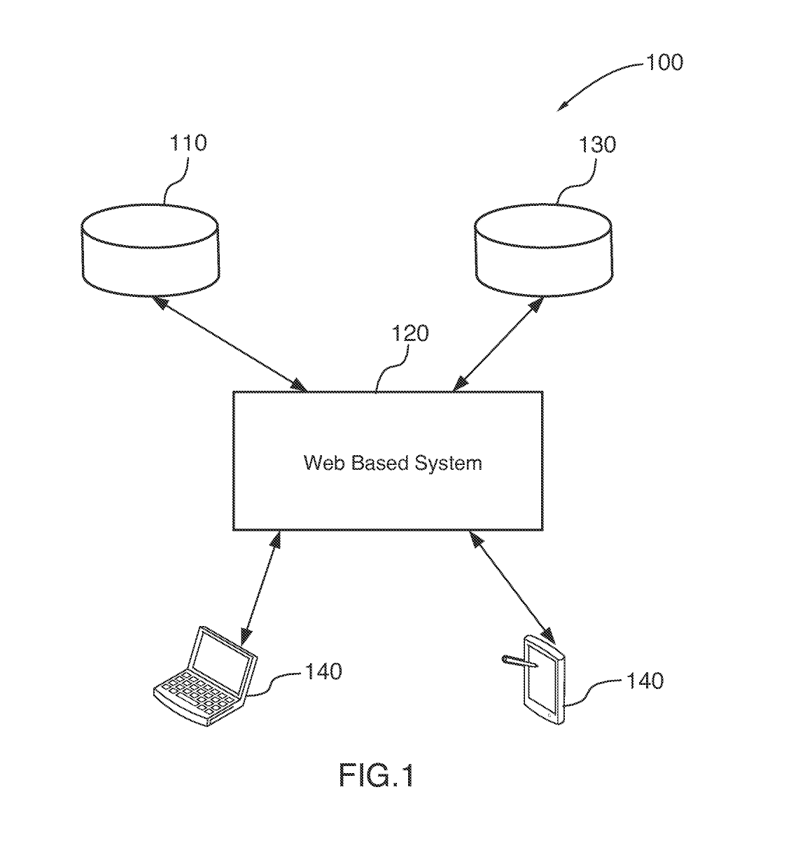

An embodiment of the present invention comprises a system and method for rating and promoting a real estate agent's business. FIG. 1, illustrates a system 100 in accordance with an embodiment of the present invention. System 100 includes: a real estate listing transaction database 110 and a web-based system 120 to rate the agents and to produce the report. As will be described below, web-based system 120 includes a publishing mechanism to render the rating that is generated. As will be further discussed below, the term rendering can include display on a screen, printing on a printer, exporting to an electronic file, or embedding on a web page. Database 110 may contain public record information that may include the official (or legal) name of each of the buyer and seller involved in the real estate property transaction. In contrast, the MLS database may not have the buyer/seller name, or the name(s) may not be in a standard format.

Web based system 100 may also be coupled to an agents performance statistic database 130. Database 130 can include pre-calculated statistics and data for an agent. In an embodiment, it may contain two tables, where one table includes specific parameters or information that defines a rating that is tailored to the agent, and the other table includes the statistics for the agent. In an embodiment, the first table includes the following data fields: agent ID, rating ID, property class, service area, client type, price range, stats interval, start date, statistics type. The service area field may be a link to another table or may contain a representation of the service area in a format supported by the system. In an embodiment, the second table contains the fields: agent ID, rating ID, start time, number of sales, rank by sales, returning customer, rank by returning customer, dollar volume, rank by dollar volume. As with other examples provided herein these are examples only and other embodiments may be implemented differently.

One or more client devices 140 may be coupled to web based system 120 through a network such as the internet. Each of web based system 120 and the client devices 140 can include any suitable computing device that includes a physical processor and a physical memory device. For example, web based system 120 can include, but is not limited to, a server computer. Client device 140 can include but is not limited to a desktop computer, a laptop computer, a notebook computer, a PDA, a tablet computer, a smartphone, a phablet, or any other suitable computing or mobile communications device.

Listing transaction database 110 is typically a dataset maintained by a local or regional Multiple Listing Service system. Various embodiments disclosed herein utilize listing transaction database 110 to generate, distribute, and promote the ratings. In an embodiment, the data can include one or more of the following fields: MLS or transaction ID, list date, list price, sold date, sale price, Seller agent, Buyer Agent, seller name, buyer name, property class, property style, living area, address, zip, city, county, neighborhood, and so on.

Various methods of rating a real estate agent are disclosed herein. These methods include: by the number of sales, by the sales' dollar volume, and by the percentage of returning customers. It will be understood that variations and combinations of those three methods (or a subset thereof), such as a weighted average, are possible. However, the various possible variations will not be discussed in this disclosure in great detail.

In an embodiment, the rate by the number of sales method counts the sales each agent closed and ranks the agents by the number of sales in the descending order. The sequence number in the sorted list is used as the rating of the agent. If more than one agent have the same number of sales, those agents are assigned the same rating, which corresponds to the minimum sequence number those agents have in the sorted list. Table 1 illustrates an example. There are 34 agents and 46 sales within the rating period. Seven (7) agents closed more than one sale. Agent 9641 closed 5 sales and therefore is placed at the top of the sorted list with a rating of 1. Agents 6228 and 31118 have the same rating 2 because both of them closed 3 sales.

TABLE 1
Rating by Number of Sales

| | | Sequence | |
|---|---|---|---|
| Agent | #of Sales in Q2 | number if the | |
| ID/Name | 2014 | sorted list | Rating |
| 9641 | 5 | 1 | 1 |
| 6228 | 3 | 2 | 2 |
| 31118 | 3 | 3 | 2 |
| 27652 | 2 | 4 | 4 |
| 28910 | 2 | 5 | 4 |
| 16297 | 2 | 6 | 4 |
| 6222 | 2 | 7 | 4 |
| 12897 | 1 | 8 | 8 |
| 2690 | 1 | 9 | 8 |
| 16550 | 1 | 10 | 8 |
| 12792 | 1 | 11 | 8 |
| 33720 | 1 | 12 | 8 |
| 15999 | 1 | 13 | 8 |
| 6756 | 1 | 14 | 8 |
| 1819 | 1 | 15 | 8 |
| 10293 | 1 | 16 | 8 |
| 17231 | 1 | 17 | 8 |
| 29598 | 1 | 18 | 8 |
| 30662 | 1 | 19 | 8 |
| 31230 | 1 | 20 | 8 |
| 2983 | 1 | 21 | 8 |
| 11489 | 1 | 22 | 8 |
| 3670 | 1 | 23 | 8 |
| 24922 | 1 | 24 | 8 |
| 12916 | 1 | 25 | 8 |
| 17560 | 1 | 26 | 8 |
| 11052 | 1 | 27 | 8 |
| 20124 | 1 | 28 | 8 |
| 1959 | 1 | 29 | 8 |
| 11593 | 1 | 30 | 8 |
| 34156 | 1 | 31 | 8 |
| 24889 | 1 | 32 | 8 |
| 2672 | 1 | 33 | 8 |
| 19565 | 1 | 34 | 8 |

In an embodiment, the rate by dollar volume method uses the sum of the prices of the sales an agent closed to rank the agents. The chances of more than one agent having the same dollar volume are much lower than the chances of more than one agent having the same number of sales. Table 2 lists the rating by sales dollar volume.

TABLE 2
Rating by Dollar Volume (with reference to rating by the
number of sales)

| Agent | #of Sales in | Rating by # | Dollar Volume | Rating by |
|---|---|---|---|---|
| ID/Name | Q2 2014 | of Sales | in Q2 2014 | Dollar Volume |
| 9641 | 5 | 1 | 2270000 | 1 |
| 6228 | 3 | 2 | 1976500 | 2 |
| 12792 | 1 | 8 | 1964000 | 3 |
| 31118 | 3 | 2 | 1809000 | 4 |
| 2690 | 1 | 8 | 1637500 | 5 |
| 16297 | 2 | 4 | 1515000 | 6 |
| 6222 | 2 | 4 | 1387000 | 7 |
| 12897 | 1 | 8 | 1250000 | 8 |
| 28910 | 2 | 4 | 1121350 | 9 |
| 16550 | 1 | 8 | 945000 | 10 |
| 27652 | 2 | 4 | 795000 | 11 |
| 33720 | 1 | 8 | 765000 | 12 |
| 15999 | 1 | 8 | 679000 | 13 |
| 6756 | 1 | 8 | 590000 | 14 |
| 1819 | 1 | 8 | 577000 | 15 |
| 10293 | 1 | 8 | 551000 | 16 |
| 17231 | 1 | 8 | 547000 | 17 |
| 29598 | 1 | 8 | 523000 | 18 |
| 30662 | 1 | 8 | 460000 | 19 |
| 31230 | 1 | 8 | 434900 | 20 |
| 2983 | 1 | 8 | 418500 | 21 |
| 11489 | 1 | 8 | 409900 | 22 |
| 3670 | 1 | 8 | 394600 | 23 |
| 24922 | 1 | 8 | 386500 | 24 |
| 12916 | 1 | 8 | 385000 | 25 |
| 17560 | 1 | 8 | 382500 | 26 |
| 11052 | 1 | 8 | 375000 | 27 |
| 20124 | 1 | 8 | 372500 | 28 |
| 1959 | 1 | 8 | 325000 | 29 |
| 11593 | 1 | 8 | 316000 | 30 |
| 34156 | 1 | 8 | 315000 | 31 |
| 24889 | 1 | 8 | 309500 | 32 |
| 2672 | 1 | 8 | 300000 | 33 |
| 19565 | 1 | 8 | 126500 | 34 |

Each real estate transaction involves a seller and a buyer. Both the seller and the buyer use real estate agents in the transaction. It is possible for both the seller and the buyer to use the same real estate agent for the same transaction. Consumers who have used the same agent in the previous transactions are referred to as returning customers. The percentage of returning customers is an indicator of the quality of services the agent performed. The agents are sorted by the percentage in the descending order of the percentage of returning customers, and rated by the sequence number the agent is placed in the list. Table 3 lists an example.

TABLE 3
Rating By Returning Customers

| | | | | Rating by the |
|---|---|---|---|---|
| | | # of | Percentage of | Percentage of |
| Agent | #of Sales | Returning | Retuning | Returning |
| ID/Name | in 2013 | Customers | Customer | Customers |
| 9641 | 12 | 7 | 58% | 1 |
| 6228 | 4 | 2 | 50% | 2 |
| 12792 | 12 | 5 | 42% | 3 |
| 31118 | 20 | 8 | 40% | 4 |
| 2690 | 10 | 4 | 40% | 4 |
| 16297 | 5 | 2 | 40% | 4 |
| 6222 | 10 | 4 | 40% | 4 |
| 12897 | 6 | 2 | 33% | 8 |
| 28910 | 3 | 1 | 33% | 8 |
| 16550 | 4 | 1 | 25% | 10 |
| 27652 | 5 | 1 | 20% | 11 |
| 33720 | 5 | 1 | 20% | 11 |
| 15999 | 8 | 1 | 12% | 13 |
| 6756 | 4 | 0 | 0% | 14 |
| 1819 | 6 | 0 | 0% | 14 |
| 10293 | 2 | 0 | 0% | 14 |
| 17231 | 1 | 0 | 0% | 14 |
| 29598 | 1 | 0 | 0% | 14 |
| 30662 | 1 | 0 | 0% | 14 |
| 31230 | 1 | 0 | 0% | 24 |

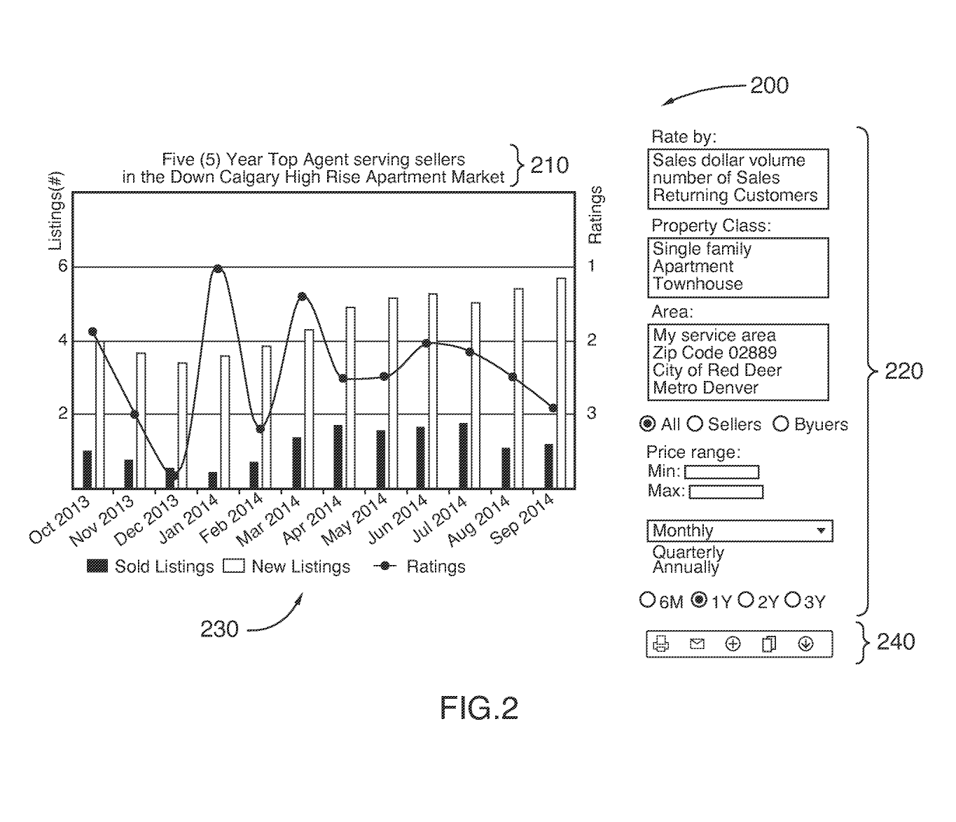

The web based system 120 includes software tools to interact with users and generate an Agent Rating report. FIG. 2 illustrates an example of a user interface 200 comprising agent rating report that may be rendered on the display of client device 140 of a user.

The agent rating report includes title or conclusion 210 of the rating. This is a synthesis in descriptive language of the chart showing in the drawing area of the system. In an embodiment, this part can be edited by the user of the system but supported by the drawing or findings. For example, it could act as a tag line in the marketing campaign of the agent.

The user interface 200 also includes menu items 220 and 240 command buttons to interact with and determine the parameters utilized for the ratings. In an embodiment, there are five groups of parameters contributing to the rating.

One group of parameters is related to the method used in the rating. For example, in an embodiment, the options are by the sales' dollar volume, by the number of sales, and returning customers.

Other parameters affect the sales data that are used in the rating.

The second parameter defines the property class involved in the rating. For example a user may decide that agents who have the expertise in the high rise apartment market should not be rated against agents whose major sales activity is in the single family market. This feature permits a user to restrict the ratings such that real estate agents from different property classes are not ranked against each other in the same report.

The third parameter defines the area for which the rating is conducted. A simple and easy comparison includes all the area the MLS covers or a city or zip code. More precise rating can be selected that is within a particular service area of the agent, for example. The service area could be selected to be one or a few communities/neighborhoods, some distance from a university or lakefront, designated service area of a school or school district, a particular high-rise or apartment building, or any area manually defined by the agent through descriptive language or drawing on a map.

The fourth parameter further divides the sales into for sellers, for buyers or for both. While some agents thrive in representing sellers, other agents are more oriented to serve buyers, and are sometimes referred to as a buyer's agent. Some agents represent both with roughly equal success.

The fifth option restricts the rating to a price range.

The sixth parameter defines the time window one comparison or rating is conducted. Typical options are monthly, quarterly, and yearly.

The seventh parameter defines the time window for which the rating is conducted.

The chart display area 230 draws the ratings within the rating period of time. The number of sales or dollar volume could be drawn as optional.

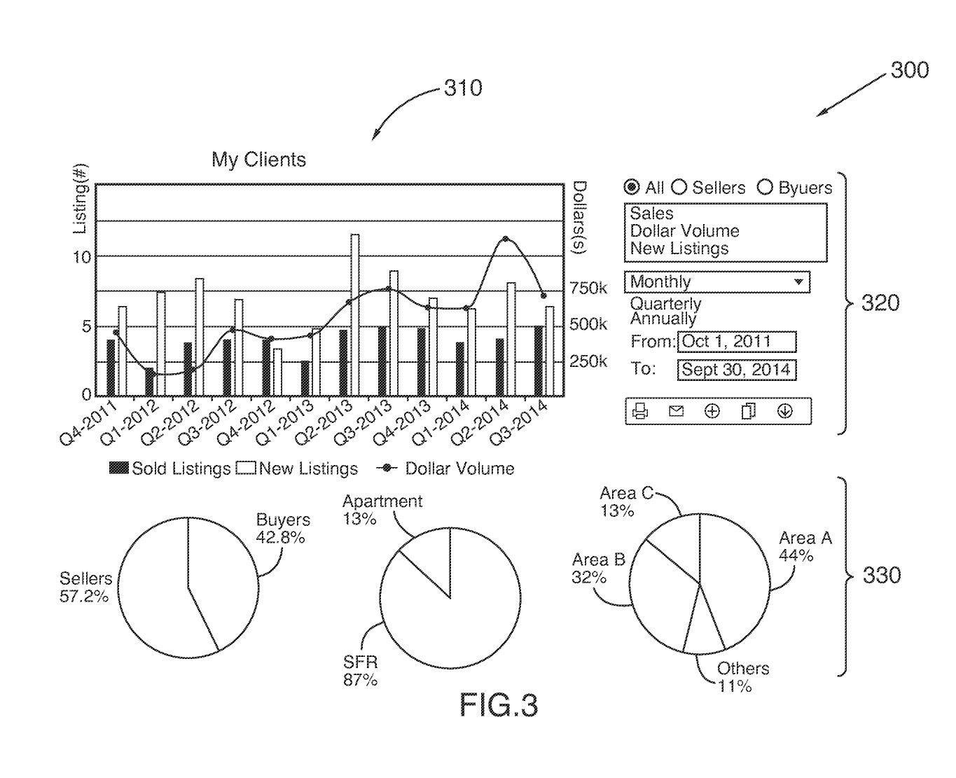

FIG. 3 illustrates a user interface 300 that could be used to categorize an agent's business, according to an embodiment. With the rating system described above, the system can be used to promote an agent's business within, for example, a certain area and a certain segment of the market.

As illustrated in FIG. 3, user interface includes a chart 310 displaying the historic sales closed by the agent, a dashboard 320 to customize the content that is displayed as part of the user interface, and pie charts 330 to illustrate the distribution of the agent's services in areas, clients, and property classes.

In an embodiment, dashboard 320 includes controls to set the following parameters.

<A> Client type: Sellers, Buyers, or Both.

<B> What statistics are to be displayed: Number of Sales, Dollar volume, or Number of New Listings. New listings apply only when Sellers is selected in <A> above.

<C> Time period to calculate each statistics: Monthly, Quarterly, or Annually.

<D> Time period covered by the chart.

<E> Commands to export the chart: Print, Email, Share, Embed, and Download.

In an embodiment, three pie charts 330 are utilized: Sellers/Buyers chart, Property Class Chart, and Service Area chart. The Sellers/Buyers chart draws the percentage of buyers and sellers. The property class chart shows the types of properties the agent served. The service area chart shows the distribution of the service areas handled by the agent.

In an embodiment, the agent promoting system can be used to determine and display what type of business the agent has been conducting. The agent rating system described above can be used to determine and display information reflective of how good the agent's business was in comparison to other agents. In an embodiment, these other agents are agents who have been serving the same market in the same area during the same time as the agent for whom the comparison is being made.

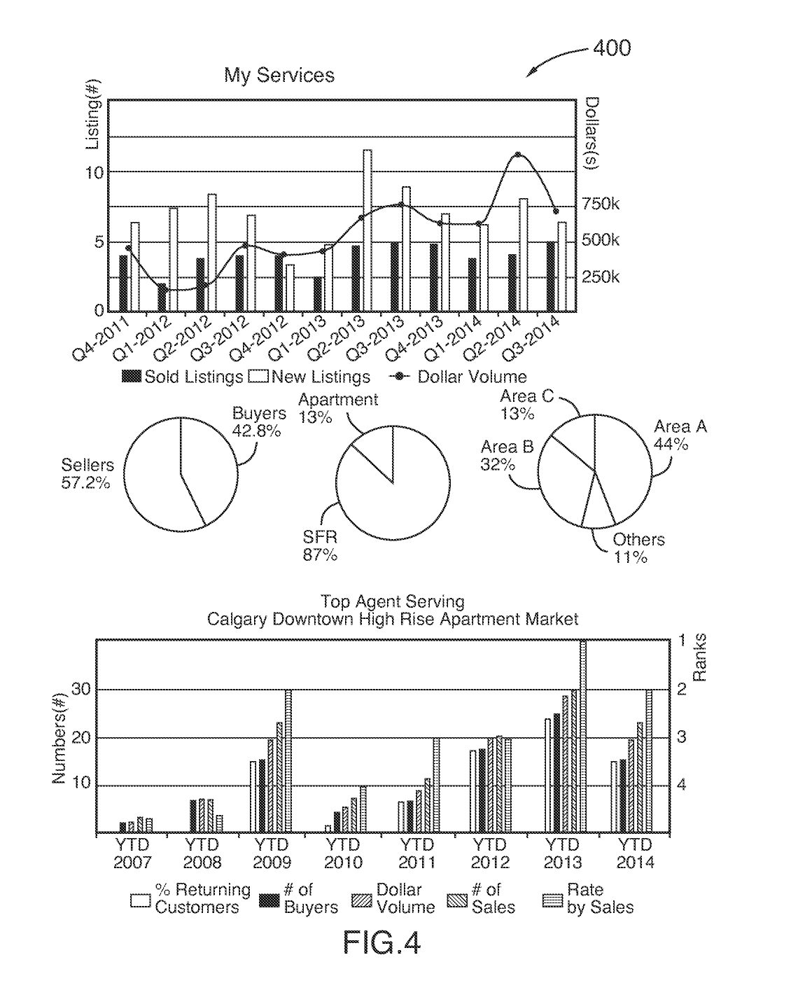

FIG. 4 gives an example of a report 400 generated by an embodiment of the agent rating and promoting system disclosed herein. In an embodiment, the report can be rendered as part of a user interface, a webpage, or electronic document. In various embodiments, the report can be printed, shared, or embedded in the agent marketing campaign. When published in an electronic media such as a web page or social network posting, the agent has the option to include the whole dashboard or a part therefore to allow users to interact with the chart. In some embodiments, the two parts can be published separately.

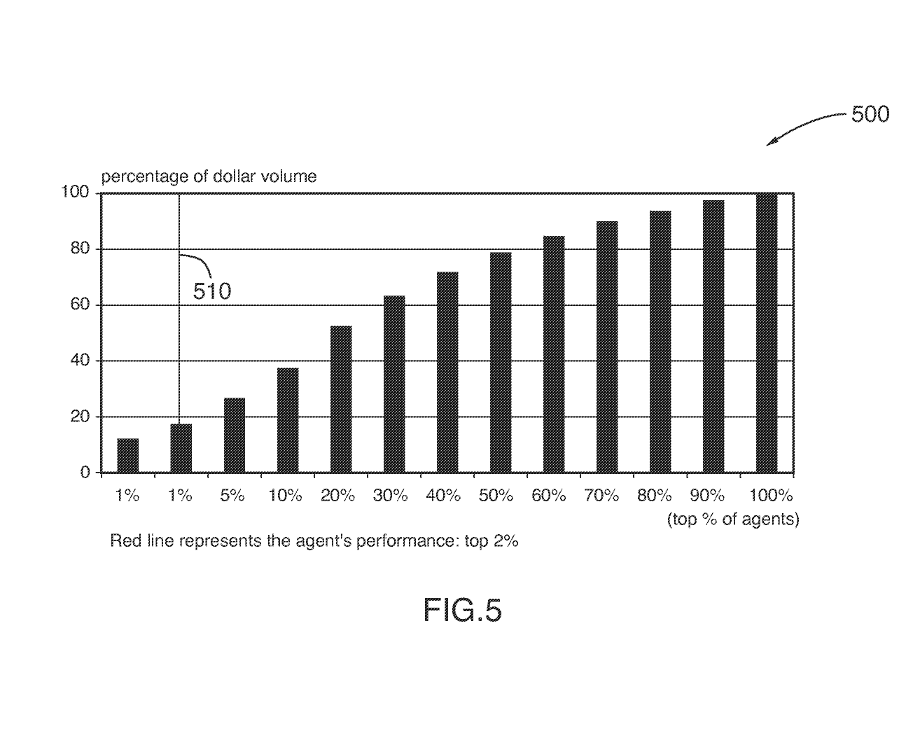

FIG. 5 illustrates a chart 500 that may be produced as part of a report in accordance with an embodiment of the present disclosure. The chart illustrates percentage of dollar volume vs. top percentage of performance. Line 510 indicates the performance of the particular agent of interest. Accordingly, the agent of interest is in the top 2% of agents involved in this rating. The remaining bars of chart 500 illustrate the distribution of performance of all of the agents involved in the rating process (i.e. the other agents whose data was used in generating the rating of the agent of interest).

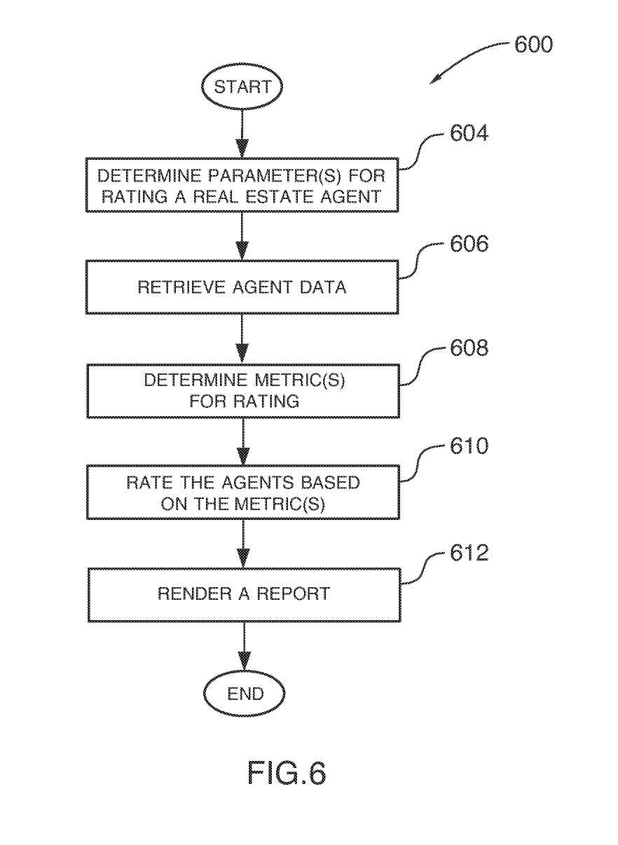

Reference is now made to FIG. 6, which is a flow chart diagram illustrating a method 600 in accordance with an embodiment of the present invention. The method may be carried out by software executed, for example, by a physical processor of system 120. Coding of software for carrying out such a method is within the scope of a person of ordinary skill in the art given the present description. The method may contain additional or fewer processes than shown and/or described, and may be performed in a different order. Computer-readable code executable by at least one processor of the system to perform the method may be stored in a computer-readable storage medium device or apparatus, which may be a non-transitory or tangible storage medium.

At 604, parameter(s) for use in the rating is/are determined. This determination can be made based on a standard set of parameters or it could be determined based on information received from elsewhere. For example, a user can enter input via client device 140 and this input is then transmitted to and received at web based system 120. The user input can include, but is not limited to, the agent(s) that is/are to be rated and the criteria upon which they should be ranked. Alternatively, web based system may be coupled to a server from which it receives parameters. For example, said server may host a web page of real estate brokerage, which may send parameters for ranking based on which real estate agent has been looked up by a prospective customer.

The parameters may include any of the above discussed criteria or parameters. For example, the parameters may indicate that the metrics based upon which the rating should be performed. The metrics can include, for example, the number of sales, dollar volume, percentage of repeat customers, other suitable criteria, or a combination thereof. The parameters may also indicate time window, service type, property type, or other parameters to be used in the rating.

At 606, agent data is retrieved. For example web based system 120 may retrieve the data from one more databases such as listing transaction database 110.

At 608, at least one metric is determined (or calculated) for each real estate agent involved in the rating. As mentioned above, these metrics can include, for example, the number of sales, dollar volume, percentage of repeat customers, other suitable criteria, or a combination thereof. Based on the parameters determined at 604 and the data retrieved at 606 metrics are determined for each of the real estate agents involved in the rating.

At 610, the real estate agents are rated. Based on the metric(s) that are determined or calculated at 608 the agents are rated. As explained above, this can involve creating a list or sequence of the agents that is ordered based on the one or more metrics calculated for the agents. In an embodiment, each agent is assigned a rating (e.g. a number) based on their sequence in the ordered list. In an embodiment, each agent that has the same overall metric value is given the same rating.

At 612, a report is rendered. This can include, for example, displaying a report on a screen of client device 140. It can also include printing a report or exporting a report to an electronic file such as an image file or other electronic document. It can also involve embedding a report in a web page. As explained above, the report can be an interactive report.

The above information is presented as background information only to assist with an understanding of the present disclosure. No determination has been made, and no assertion is made, as to whether any of the above might be applicable as prior art with regard to the present disclosure.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A computer implemented method of rating a real estate agent, the method being executed by a physical processor of said computer, the method comprising:
retrieving agent sales data stored at a memory device;
determining at least one common sales metric value for each of the agents;
sorting the agents to produce a sequence listing of the agents in an order based on the determined sales metric;
assigning a rating to each agent in accordance with a sequence number of the agent in the sorted list;
rendering a report based on the rating.

2. The method of claim 1, wherein the sales metric comprises a number of sales in a time period.

3. The method of claim 1, wherein the sales metric comprises a dollar volume, the dollar volume comprising a sum of the sale price of the sales closed by an agent in a time period.

4. The method of claim 1, further comprising:
receiving user input for restricting the rating based on at least one criterion; and
restricting the data used in the determining step based on the user input.

5. The method of claim 4, wherein the criterion comprises a service type of an agent, the service type including the categories:
seller's agent, the seller's agent category corresponding to agents that represent sellers;
buyer's agent, the buyer's agent category corresponding to agents that represent both buyers; and
both, the both category corresponding to agents that represent both buyers and sellers.

6. The method of claim 4, wherein the criterion comprises a property type.

7. The method of claim 4, wherein the criterion comprises a service area.

8. The method of claim 7, wherein the criterion the service area includes at least one of: community/neighborhood boundaries, school or school district service boundaries, city/county or zip code area boundaries, a distance from a university or lake front, a foot print of one high-rise apartment building, an area drawn or defined by a user.

9. The method of claim 4, wherein the criterion comprises a sales price.

10. The method of claim 4, wherein the criterion comprises a time window.

11. A computer readable medium storing statements and instructions for execution by a processor for executing the method of claim 1.

12. A system for rating a real estate agent, the system comprising at least one physical processor, the processor configured and adapted to:
retrieve agent sales data stored at a memory device;
determine at least one common sales metric for each of the agents;
sort the agents to produce a sequence listing of the agents in an order based on the determined sales metric;
assign a rating to each agent in accordance with a sequence number of the agent in the sorted list;
render a report based on the rating.

13. The system of claim 12, wherein the processor is further configured and adapted to export a rating chart.

14. The system of claim 13, wherein exporting a rating chart comprises at least one of the following:
exporting an image file comprising a rating chart;
exporting a dynamic rating chart;
emailing an image file comprising a rating chart;
emailing a dynamic rating chart.

15. The system of claim 12, wherein the processor is further configured and adapted to automatically determine a set of criteria that produces a best rating for a selected agent.

16. The system of claim 15, wherein the set of criteria is selected from the group consisting of: service type, service area, property classes, price range, and time period.

17. The system of claim 15, wherein the processor is configured and adapted to:
perform a series of rating using different criteria parameters; and
select the parameters that result in the best rating for the selected agent.

18. The system of claim 12, wherein the rendered report comprises a chart for displaying an agent's current and historic listings.

19. The system of claim 18, wherein the processor is further configured and adapted to export the chart as a dynamic chart to a webpage.

20. The system of claim 18, wherein system is coupled to a real estate listing web portal; and wherein the processor is further configured and adapted to match a customer's request for service to an agent based on a rating of the agent and a customer's requested service area.
